(19) United States
(12) Patent Application Publication
(10) Pub. No.: US 2008/0211204 A1
(43) Pub. Date: Sep. 4, 2008

(54) Scooter Frame

(75) Inventors: Chin Hsiung LEE, Sinying City (TW); Chen CHUAN-I, Tai-Bao City (TW); Lin Ching-Yao, Meishan Township (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LINK TREASURE LIMITED, Road Town (VG)

(21) Appl. No.: 12/031,883

(22) Filed: Feb. 15, 2008

(30) Foreign Application Priority Data
Feb. 15, 2007 (TW) 096203017

(51) Int. Cl. B62K 7/02

(52) U.S. Cl. 280/281.1

(57) ABSTRACT

A scooter frame provides with a front frame and a rear frame both are interconnected by a spring-loaded latch in a double overlapping relation. The front frame has a front portion connecting at least a front wheel and a tiller post, a rear portion having a lower transverse rod, a seat post for supporting a seat and an upper holding rack extended from the seat post. The rear frame has a front portion formed with a lower holding rack for retaining the lower transverse rod and an upper transverse rod for overlapping with the upper holding rack. By this way, the scooter frame can be fabricated in different sites and separate product lines, and to be assembled at another product lines without use extra tools.

### RELATED APPLICATIONS

This application claims the benefit under 35 U.S.C. § 119(d) of Taiwan Patent Application 096203017, filed Feb. 15, 2007, the disclosure of which is incorporated herein by reference in its entirety.

### BACKGROUND OF THE INVENTION

1. Field of the Invention

This invention relates to a scooter frame. More specifically, this invention relates to a scooter frame that comprises a front frame having a holding rack and a lower transverse rod, and a rear frame having a holding rack and an upper transverse rod, both are interconnected by a spring-loaded latch atop the holding rack in a double overlapping relation with each other.

2. Description of the Related Art

Nowadays, more and more people can gain a long life through the success of advanced medical technologies. The aged population is increasing and elderly people becoming one of the major groups in society. The products design for elderly people now becoming more and more important and competitive day by day. For help the elderly people to take care of their daily transportation, the powered scooter is one of the choices as well as the power wheelchairs, walking sticks or walkers.

The conventional powered scooter basically comprises at least a cover, a frame, a seat and a driving system. The scooter frame may be welded integrally for ensure the rigidity and structure strength; however, this makes the scooter becoming more volume occupancy, difficult in fabricating processes and assembly. This would higher the shipping cost and price in the market.

### SUMMARY OF THE INVENTION

In order to simplify the fabricating processes and assembly works and to save the shipping cost, the present invention provides a scooter frame with a front and rear frame interconnected by a spring-loaded latch in a double overlapping relation. By this way, the scooter frame can be fabricated in different sites and separate product lines, and to be assembled at another product lines without use extra tools.

According to this invention, the front frame of the scooter frame embodiment may have a front portion for connecting at least a front wheel and a tiller post, a horizontal portion for supporting at least a battery container, a seat post, a lower transverse rod and an upper holding rack.

The rear frame has a front portion and rear portion. The front portion has a lower holding rack, a holding claw and an upper transverse rod for connecting with the rear portion of the front frame in the double overlapping configuration. The rear portion of the rear frame connects at least a rear wheel and preferably a stabilizing wheel.

The lower transverse rod of the front frame is rest upon and retained by the lower holding rack of the rear frame. The spring-loaded latch is operatively mounted atop the upper holding rack of the front frame and so as to lock the upper transverse rod of the rear frame in an overlapping relation.

Additional features and advantages of the invention will be set forth in the description to follow, and in part will be apparent from the description, or may be learned by practice of the invention. The objectives and other advantages of the invention will be realized and attained by the structure particularly pointed out in the written description and claims as well as the appended drawings.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a side view of a powered scooter.

FIG. 2 is a perspective view of the scooter frame according to the present invention.

FIG. 3 is an exploded side view of the scooter frame of FIG. 2.

FIG. 4 is an enlarged fragmentary side view of the scooter frame of FIG. 2.

FIG. 5 is a perspective view of the scooter frame of FIG. 2 while being assembled.

FIG. 6 is a perspective view illustrated an alternative embodiment of the scooter frame according to the present invention.

### DETAILED DESCRIPTION OF THE PREFERRED EMBODIMENTS

Reference will now be made in detail to the preferred embodiments of the present invention, examples of which are illustrated in the accompanying drawings.

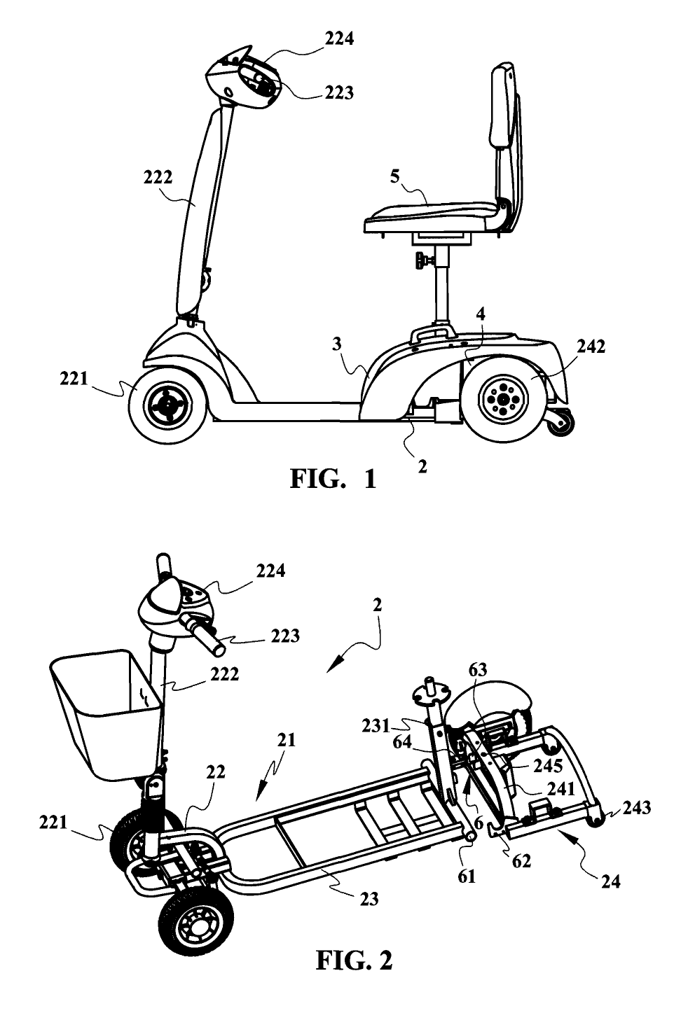

Referring to FIG. 1, a scooter typically comprises a scooter frame 2, a cover 3, a driving device 4, a seat 5, and at least a front wheel 221, a tiller post equipped with a pair of handlebars 223 and a control penal 224.

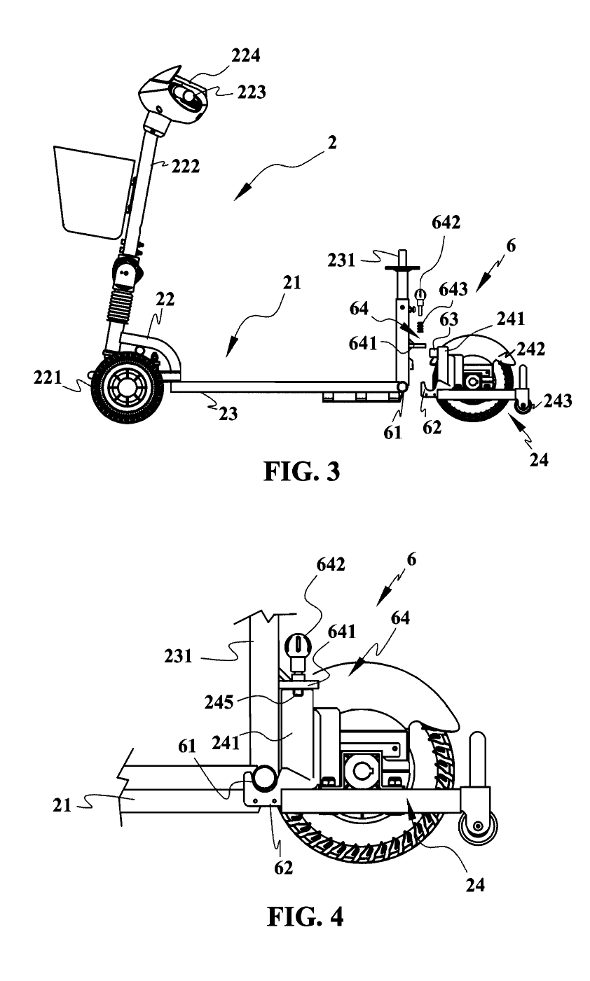

Referring to FIGS. 2 to 5, the embodiment of scooter frame 2 according to the present invention comprises a front frame 21 and rear frame 24 interconnected by a connecting mechanism 6 to build a double overlapping relation between the front frame 21 and the rear frame 24.

The front frame 21 of the embodiment of scooter frame 2 has a front portion 22 for connecting at least a front wheel 221 and a tiller post 222, a horizontal portion 23 for supporting at least a battery container (not shown), and a rear portion which has a seat post 231, a lower transverse rod 61 and an upper holding rack 641.

The seat post 231 is uprightly mounted at the rear side of the front frame 21 for supporting a seat 5 thereupon. The lower end of the seat post 231 may be welded or firmly mounted with the lower transverse rod 61. The lower transverse rod 61 has two ends extended transversally for connecting with the rear frame 24.

The rear frame 24 has a front portion and rear portion. The rear portion of the rear frame 24 connects at least a rear wheel 242 and preferably a stabilizing wheel 243. The front portion has a lower holding rack 62 for holding the ends of the lower transverse rod 61, a holding claw 63 for holding the seat post 231 and an upper transverse rod 241 for connecting with the rear portion of the front frame 21 in the double overlapping configuration. It would also be appreciated, the lower holding rack may be formed with an indent for engaging and retaining the lower transverse rod.

The connecting mechanism 6 includes a locking mechanism 64 which comprises a spring-loaded latch 642. Beginning to assemble the scooter frame 2, the lower transverse rod 61 of the front frame 21 is rested upon and retained by the lower holding rack 62 of the rear frame 24, and the spring-loaded latch 642 is operatively mounted atop the upper holding rack 641 of the front frame 21 to lock the upper transverse rod 241 of the rear frame 24 in an overlapping relation.

The upper transverse rod 241 may be formed with a locking aperture 245 or an indent atop thereupon for engaging with the spring-loaded latch 642. The spring-loaded latch 642 may comprise a stem which is biased by a spring 643 downwardly and passes through the upper holding rack 641 to insert into the locking aperture 245, so as to interconnect and detach the front frame 21 and the rear frame 24 simply by hand without any extra tools.

Alternatively, the stem of the spring-loaded latch 642 may be formed with a threaded end, and the upper transverse rod relatively formed with a threaded hole, that permit the threaded end of the stem threaded therein for connecting the upper holding rack to the upper transverse rod.

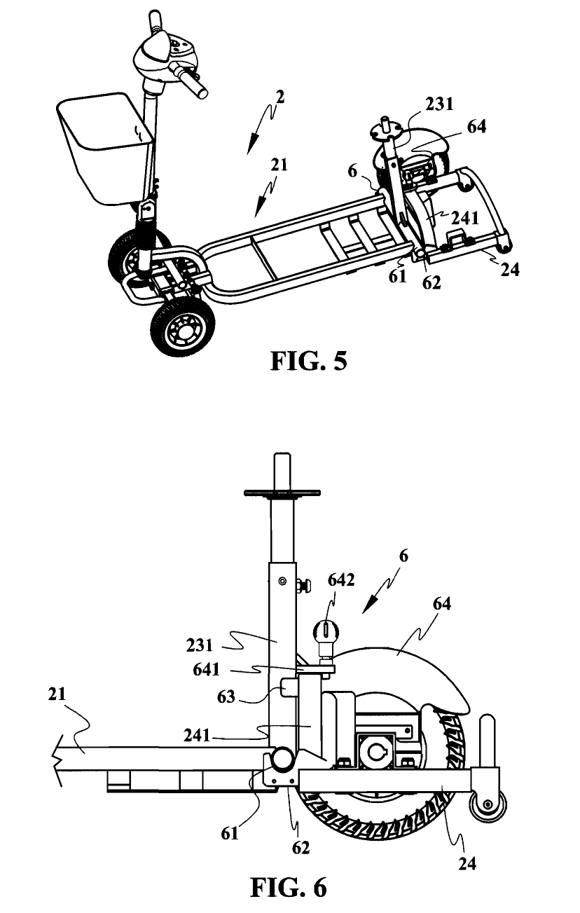

Referring to FIG. 6, the spring-loaded latch 642 may be not necessary to lock into the locking aperture 245 as being illustrated in FIG. 5. The alternative in this embodiment, the spring-loaded latch 642 is latched on one side of the upper transverse rod. All the embodiments as being illustrated above, the scooter frame 2 can be fabricated in different sites and separate product lines, and to be assembled at another product lines without use extra tools. By this way, the manufacturer can simplify the fabricating processes and assembly works and save the shipping cost.

It will be apparent to those skilled in the art that various modifications and variations can be made in the infant carrier, stroller, and base system of the present invention without departing from the spirit or scope of the invention. Thus, it is intended that the present invention cover the modifications and variations of this invention provided they come within the scope of the appended claims and their equivalents.

What is claimed is:

1. A scooter frame, comprising:
a front frame, having a front portion connecting at least a front wheel and a tiller post, a rear portion having a lower transverse rod, a seat post for supporting a seat and an upper holding rack extended from the seat post;
a rear frame, having a front portion formed with a lower holding rack for retaining the lower transverse rod and a upper transverse rod for overlapping with the upper holding rack; and
a connecting mechanism for interconnecting the front frame and the rear frame.

2. The scooter frame of claim 1, wherein the rear frame further has a holding claw for holding the seat post.

3. The scooter frame of claim 1, wherein the front frame comprises a horizontal portion for supporting a battery container.

4. The scooter frame of claim 1, wherein the lower transverse rod has two ends extending transversely.

5. The scooter frame of claim 1, wherein the seat post is welded and connected with the rear frame.

6. The scooter frame of claim 1, wherein the rear frame has a rear portion connected with a stabilizing wheel.

7. The scooter frame of claim 1, wherein the rear frame connects a pair of rear wheel.

8. The scooter frame of claim 1, wherein the connecting mechanism includes a locking mechanism for detachably connecting the upper holding rack to the upper transverse rod.

9. The scooter frame of claim 8, wherein the locking mechanism includes a spring-loaded latch detachably connected the upper holding rack to the upper transverse rod.

10. The scooter frame of claim 8, wherein the upper transverse rod is formed with a locking aperture.

11. The scooter frame of claim 8, wherein the upper transverse rod is formed with an indent.

12. The scooter frame of claim 8, wherein the lower holding rack is formed with an indent for retaining the lower transverse rod.

13. The scooter frame of claim 9, wherein the spring-loaded latch comprises a stem biased by a spring downwardly and passes through the upper holding rack to insert into the upper transverse rod.

14. The scooter frame of claim 9, wherein the seat post is uprightly mounted at the rear side of the front frame for supporting a seat thereupon.

15. The scooter frame of claim 9, wherein the spring-loaded latch comprises a stem formed with a threaded end, and the upper transverse rod is formed with a threaded hole, so as to permit the threaded end of the stem threaded into the threaded hole for connecting the upper holding rack to the upper transverse rod.
